(19) United States
(12) Patent Application Publication
(10) Pub. No.: US 2007/0054509 A1
(43) Pub. Date: Mar. 8, 2007

(54) Apparatus containing multifunctional input and output jack and method using the same

(75) Inventors: Nam-hoon Baek, Hwaseong-si (KR); A-in Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/515,859

(22) Filed: Sep. 6, 2006

(30) Foreign Application Priority Data
Sep. 7, 2005 (KR) 10-2005-0083322

(51) Int. Cl. H01R 29/00

(52) U.S. Cl. 439/52

(57) ABSTRACT

An apparatus including a multifunctional input and output jack and a method using the same are provided, in which a control unit generates a control voltage according to predetermined settings, a signal-processing unit processes a progress path so that at least one of control and image signals with respect to a predetermined external device is input or output according to the control voltage, a switch unit processes a progress path so that a sound signal with respect to the external device is input or output according to the control voltage, and an input and output unit that inputs or outputs at least one of the control, image and sound signals according to the progress path.

### CROSS-REFERENCE TO RELATED APPLICATIONS

This application claims the benefit under 35 U.S.C. § 119(a) of Korean Patent Application No. 10-2005-0083322 filed on Sep. 7, 2005 in the Korean Intellectual Property Office, the entire disclosure of which is hereby incorporated by reference.

### BACKGROUND OF THE INVENTION

1. Field of the Invention

The present invention relates to an apparatus including a multifunctional input and output jack and a method using the same. More particularly, the present invention relates to an apparatus including a multifunctional input and output jack and a method using the same, which selectively receives or outputs sound and image signals via a single jack by controlling a signal flow using an analog switch.

2. Description of the Related Art

A portable convergence device which is a small portable device has functions of a camcorder, a digital camera, a MP3 player, a voice recorder, a data storage device, and a personal computer (PC) camera.

A user can take a picture of a subject even while moving and store the picture as a digital still image or as a moving picture via the portable convergence device, and the taken image can then be played back later. That is, a user can play back a stored multi-media file via a display means such as a view finder or a liquid crystal display (LCD) monitor of the portable convergence device, or via an additional device having a display means. When a user wants to play a multi-media file via an additional device, the stored multi-media file may be output through a cord connected to the jack of the portable convergence device.

A user may process data of an external device via the portable convergence device. For example, data can be displayed by copying predetermined data stored in an external device to a portable convergence device, or by transmitting a multi-media file of the external device to a portable convergence device. The portable convergence device can receive data from the external device via a cord connected to its jack.

The portable convergence device performs input and output of data via a cord connected to the jack, whereas conventional portable convergence devices have separate jacks for inputting and outputting.

That is, a user can output data stored in the portable convergence device via an output jack, and can input data in the portable convergence device via an input jack.

As the size of a portable convergence device becomes smaller due to a development of a memory integration technology and an application-specific integrated circuit (ASIC) technology, having two jacks in a portable convergence device is an unavoidable spatial-limitation problem.

Therefore, there is a need for an improved method of inputting and outputting data using component(s) that require(s) only a minimal or small amount space.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide selectively input or output signals by controlling a signal flow using an analog switch via a single jack.

This and other objects, features and advantages of the present invention will become apparent to those skilled in the art upon review of the following description.

According to an aspect of exemplary embodiments of the present invention, there is provided an apparatus including a multifunctional input and output jack, in which a control unit generates a control voltage according to a predetermined setting, a signal-processing unit processes a progress path so that at least one of control and image signals with respect to a predetermined external device is input or output according to the control voltage, a switch unit processes a progress path so that a sound signal with respect to the external device is input or output according to the control voltage, and an input and output unit inputs or outputs at least one of the signals according to the progress path.

According to another aspect of exemplary embodiments of the present invention, there is provided a multifunctional input and output method, in which a control voltage is generated according to predetermined settings, a progress path is processed so that at least one of control and image signals with respect to a predetermined external device is input or output according to the control voltage, a progress path is processed so that the sound signal with respect to the external device is input or output according to the control voltage, and at least one of the signals is input or output according to the progress path.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram illustrating an apparatus including a multifunctional input and output jack according to an exemplary embodiment of the present invention;

FIG. 2 illustrates a circuit configuration of an apparatus that outputs a sound signal according to an exemplary embodiment of the present invention;

FIG. 3 illustrates a circuit configuration of an apparatus that outputs image and sound signals according to an exemplary embodiment of the present invention;

FIG. 4 illustrates a circuit configuration of an apparatus that receives image and sound signals according to an exemplary embodiment of the present invention;

FIG. 5 illustrates a circuit configuration of an apparatus that outputs a control signal, and inputs image and sound signals according to an exemplary embodiment of the present invention;

FIG. 6 is a flow chart illustrating a multifunctional input and output process according to an exemplary embodiment of the present invention;

FIG. 7 is a flow chart illustrating a process for outputting a sound signal according to an exemplary embodiment of the present invention;

FIG. 8 is a flow chart illustrating a process for outputting image and sound signals according to an exemplary embodiment of the present invention;

FIG. 9 is a flow chart illustrating a process for receiving image and sound signals according to an exemplary embodiment of the present invention;

FIG. 10 is a flow chart illustrating a process for outputting a control signal, and inputting image and sound signals according to an exemplary embodiment of the present invention.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention will be described in detail with reference to the accompanying drawings.

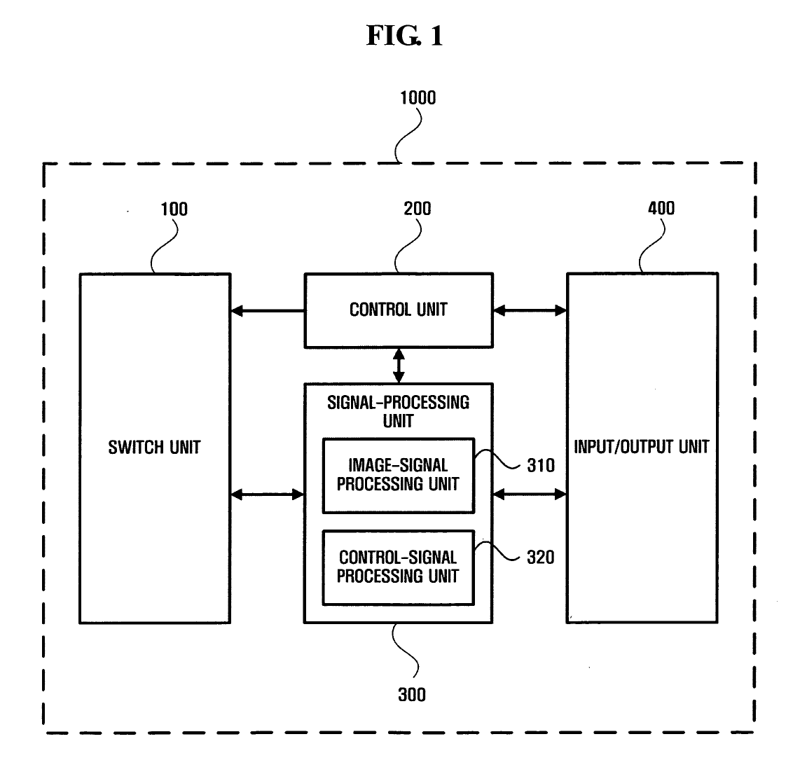

FIG. 1 is a block diagram illustrating an apparatus including a multifunctional input and output jack according to an exemplary embodiment of the present invention. The apparatus 1000 includes a switch unit 100, a control unit 200, a signal-processing unit 300 and an input and output unit 400.

The apparatus 1000, which is connected to an external device, may transmit image, sound and control signals to the external device, or may receive signals from the external device. Hereinafter, the process where a signal is transmitted from the external device to the apparatus 1000 is referred to as input, and the process where a signal is transmitted from the apparatus 1000 to the external device is referred to as output.

The control unit 200 generates a control voltage according to the predetermined settings. The settings include the types of control, image or sound signals to be input or output, and the settings may be set by the user.

That is, a user sets a type, input and output of signals via an input means such as buttons included in the apparatus 1000. For example, a control unit 200 may generate the corresponding control voltage by selecting one of output of a sound signal, input of a sound signal, output of sound and image signals, and input of sound and image signals.

A control signal for controlling the external device is generated by a control unit 200. When a user controls the external device via an input means such as the buttons included in the device 1000, the control unit 200 generates the corresponding control signal.

The control voltage includes at least one of a high-level voltage and a low-level voltage. The high-level voltage may have the value in the range of 0.4 to 0.8V, and the low-level voltage may have a value of 0 V, that is, ground potential.

The signal-processing unit 300 processes a progress path so that at least one of control and image signals with respect to an external device may be input or output according to the control voltage generated by the control unit 200.

The signal-processing unit 300 may include an image-signal processing unit 310 and a control-signal processing unit 320. The image-signal processing unit 310 processes a progress path by determining input and output of an image signal according to the control voltage. The control-signal processing unit 320 determines whether to input the control signal input by a user according to the control voltage.

The switch unit 100 processes a progress path, which illustrates a pathway made by a switch, so that a sound signal with respect to an external device is input or output according to the control voltage.

The switch unit 100, including a plurality of switches, processes a progress path by determining input and output of a sound signal according to the control voltage.

The input and output unit 400 inputs and outputs at least one of control, image and sound signals according to the progress path. That is, the input and output unit 400, with a cord connected to the external device via a jack, inputs and outputs at least one of control, image and sound signals. The input and output unit 400 includes a left sound signal input and output terminal, a right sound signal input and output terminal, an image signal input and output terminal, a detect signal terminal, and a ground terminal.

The left-sound-signal input and output terminal and the detect signal terminal contact each other in a status where a cord of the external device is not connected to the input and output unit 400. When the cord of the external device and the input and output unit 400 are connected, the left sound signal input and output terminal and the detect signal terminal are disconnected.

When the left sound signal input and output terminal and the detect signal terminal are disconnected, the control unit 200 detects that the cord of the external device is inserted therein. For example, the voltage of the detect signal terminal is a low level when the left sound signal input and output terminal and the detect signal terminal are in contact with each other, and the voltage of the detect signal terminal is a high level when the left sound signal input and output terminal and the detect signal terminal are disconnected; therefore, the control unit 200 may detect that the cord of the external device is inserted therein.

The control unit 200 may determine the type of external devices and the input and output of signals by using the settings. As a result, the control unit 200 supplies the control voltage to the switch unit 100 and the signal-processing unit 300, thereby inputting or outputting the corresponding signal.

For reference, a control voltage, generated by the control unit 200, is transmitted to the switch unit 100 and the signal-processing unit 300 not as a single voltage but as a commensurate or corresponding number of voltages according to the settings. For example, the control unit 200 may transmit a high level to the switch unit 100, and a low level to the signal-processing unit 300. For example, the control unit 200 may transmit the high level voltage to the image-signal processing unit 310, and the low level voltage to the control-signal processing unit 320.

To set a progress path of a sound signal, the control unit 200 may also transmit a high level voltage to a specific switch, and a low level voltage to another switch for a proper operation of each switch composing the switch unit 100.

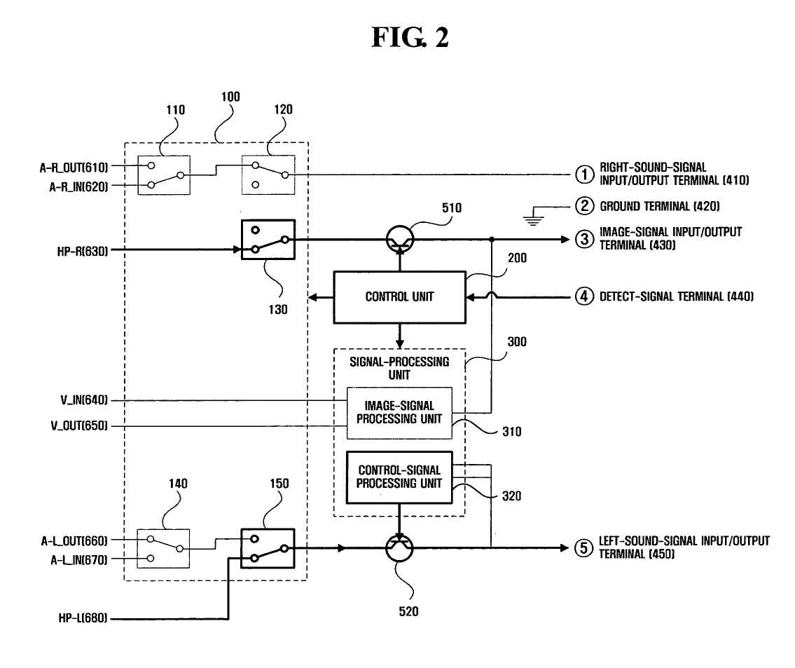

FIG. 2 illustrates a circuit configuration of an apparatus that outputs a sound signal according to an exemplary embodiment of the present invention.

To output a sound signal to an external device such as an earphone, a user inputs the corresponding settings via an input means such as buttons included in the apparatus 1000.

For reference, A-L_IN 670, A-R_IN 620, A-L_OUT 660, A-R_OUT 610, HP-L 680, HP-R 630, V_IN 640 and V_OUT 650 illustrated in FIGS. 2 to 5 refer to the terminal connected to an inner module of the apparatus 1000. Specifically, A-L_IN 670 and A-R_IN 620 respectively refer to a left and right input terminals of a sound signal, A-L_OUT 660 and A-R_OUT 610 respectively refer to a left and right output terminals of a sound signal, HP-L 680 and HP-R 630 refer to a left and right output terminals of a headphone sound signal, and V_IN 640 and V_OUT 650 respectively refer to input and output of an image signal.

When the settings are input and the cord of the external device is inserted into the input and output unit 400, a left-sound-signal input and output terminal 450 and a detect signal terminal 440 are disconnected, which is detected by the control unit 200. Then, the control unit 200 determines the type of external device through the settings. That is, the control unit 200 detects that the external device has received a sound signal, and then outputs the sound signal via a sound output means.

The control unit 200 supplies a control voltage to the control-signal processing unit 320, whereby the control-signal processing unit 320, without connecting to the left-sound-signal input and output terminal 450 internally, supplies a high level voltage to the second transistor 520 in order for the-left-sound-signal input and output terminal 450 to be connected to a fifth switch 150.

The control unit 200 connects the fifth switch 150 to HP-L 680 by supplying a control voltage to the switch unit 100. As a result, the left-sound-signal input and output terminal 450 is connected to HP-L 680, and a left sound signal generated by a sound codec (not shown) is transmitted to the left-sound-signal input and output terminal 450 via HP-L 680.

The control unit 200 connects a third switch 130 to HP-R 630 by supplying a control voltage to the switch unit 100. As a result, the image-signal input and output terminal 430 is connected to HP-R 630, and a right sound signal generated by a sound codec (not shown) is transmitted to the image-signal input and output terminal 430 via HP-R 630.

As a result, a sound signal generated by the apparatus 1000 is output to the external device.

For reference, the ground terminal 420 adjusts the electric potential between the apparatus 1000 and the external device.

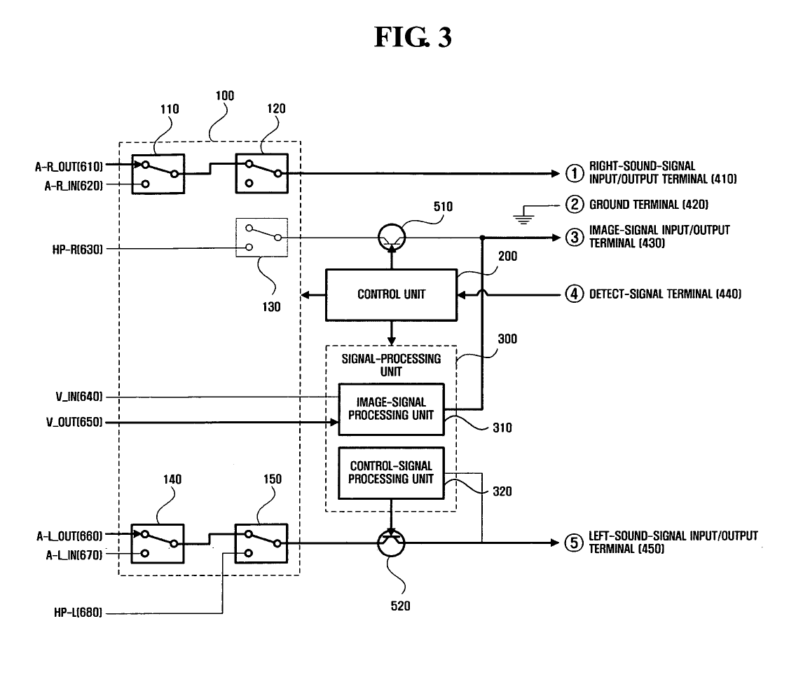

FIG. 3 illustrates a circuit configuration of an apparatus that outputs image and sound signals according to an exemplary embodiment of the present invention.

To output image and sound signals to an external device having an image and sound output means such as a television (TV) or a PC, a user inputs the corresponding settings by using an input means such as buttons included in the apparatus 1000.

If the cord of the external device is inserted into the input and output unit 400 after the settings are input, the left-sound-signal input and output terminal 450 and the detect signal terminal 440 are disconnected, which is detected by the control unit 200. Then, the control unit 200 determines the type of external device through the settings. That is, the control unit detects that the external device receives image and sound signals, and then outputs the image and sound signals via image and sound output means.

The control unit 200 supplies a control voltage to the control-signal processing unit 320, whereby the control-signal processing unit 320, without connecting to the left-sound-signal input and output terminal 450 internally, supplies a high level voltage to the second transistor 520 in order for the left-sound-signal input and output terminal 450 to be connected to the fifth switch 150.

The control unit 200 connects a fourth switch 140 to A-L_OUT 660, and connects the fifth switch 150 to the fourth switch 140 by supplying the control voltage to the switch unit 100. As a result, the left-sound-signal input and output terminal 450 is connected to A-L_OUT 660, and a left sound signal generated by a sound codec (not shown) is transmitted to the left-sound-signal input and output terminal 450 via A-L_OUT 660.

The control unit 200 connects a first switch 110 to A-R_OUT 610, connects a second switch 120 to the first switch 110, and does not connect a third switch 130 to HP-R 630 by supplying the control voltage to the switch unit 100. As a result, the right-sound-signal input and output terminal 410 is connected to A-R_OUT 610 and the right sound signal generated by a sound codec (not shown) is transmitted the right-sound-signal input and output terminal 450 via A-R_OUT 610.

The control unit 200 does not connect the image-signal input and output terminal 430 to the third switch 130 by supplying a low level voltage to the first transistor 510, and transmits an image signal generated by an image codec (not shown) to the image-signal input and output terminal 430 via V_OUT 650 by supplying the control voltage to the image-signal processing unit 310.

Therefore, image and sound signals generated by the apparatus 1000 are output to the external device.

For reference, the ground terminal 420 adjusts the electric potential between the apparatus 1000 and the external device.

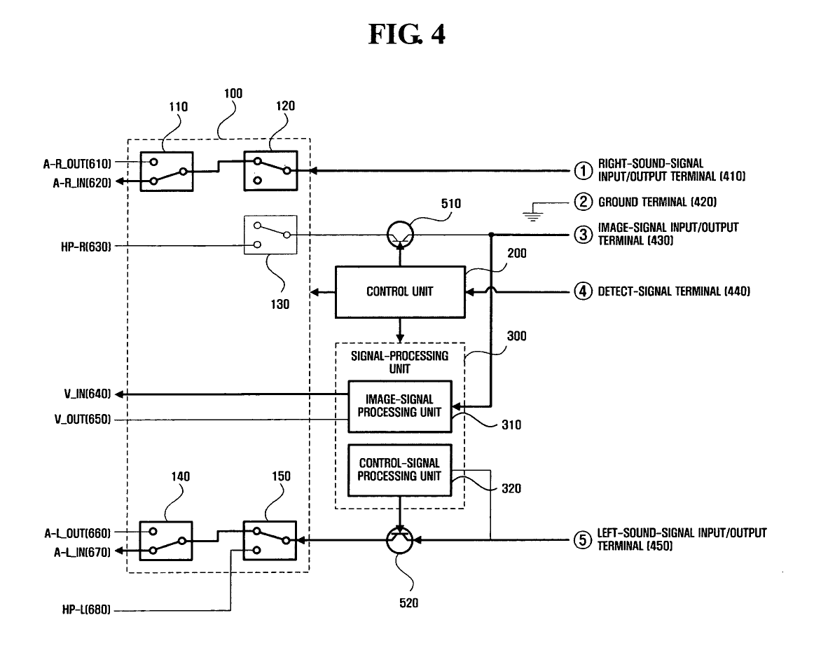

FIG. 4 illustrates a circuit configuration of an apparatus in which an image signal and a sound signal are input according to an exemplary embodiment of the present invention.

A user inputs the corresponding settings via an input means such as buttons included in the apparatus 1000 in order to receive image and sound signals from the external device (for example, a digital video disc (DVD) player).

When the cord of the external device is inserted into the input and output unit 400 after the settings are input, the left-sound-signal input and output terminal 450 and the detect-signal terminal 440 are disconnected, which is detected by the control unit 200. The control unit 200 determines the type of external device through the settings. That is, the control unit detects that the external device outputs image and sound signals.

The control unit 200 supplies a control voltage to the control-signal processing unit 320, whereby the control-signal processing unit 320, without connecting to the left-sound-signal input and output terminal 450 internally, supplies a high level voltage to the second transistor 520 in order for the left-sound-signal input and output terminal 450 to be connected to the fifth switch 150.

The control unit 200 connects the fourth switch 140 to A-L_IN 670 and connects the fifth switch 150 to the fourth switch 140 by supplying a control voltage to the switch unit 100. As a result, the left-sound-signal input and output terminal 450 is connected to A-L_IN 670 and a sound signal, which is input to the left-sound-signal input and output terminal 450, is transmitted to a sound codec (not shown) in the apparatus via A-L_IN 670.

The control unit 200 connects the first switch 110 to A-R_IN 620, connects the second switch 120 to the first switch 110, and does not connect the third switch 130 to HP-R 630 by supplying a control voltage to the switch unit 100. As a result, the right sound signal input and output terminal 410 is connected to A-R_IN 620, and a sound signal, which is input to the right-sound-signal input and output terminal 410, is transmitted to a sound codec (not shown) in the apparatus via A-R_IN 620.

The control unit 200 does not connect the image-signal input and output terminal 430 to the third switch 130 by supplying a low level voltage to a first transistor 510, and transmits an image signal, which is input to an image-signal input and output terminal 430, to V_IN 640 by supplying a control voltage to the image-signal processing unit 310.

Therefore, image signals and sound signals of the external device are input to the apparatus 1000.

For reference, the ground terminal 420 adjusts the electric potential between the apparatus 1000 and the external device.

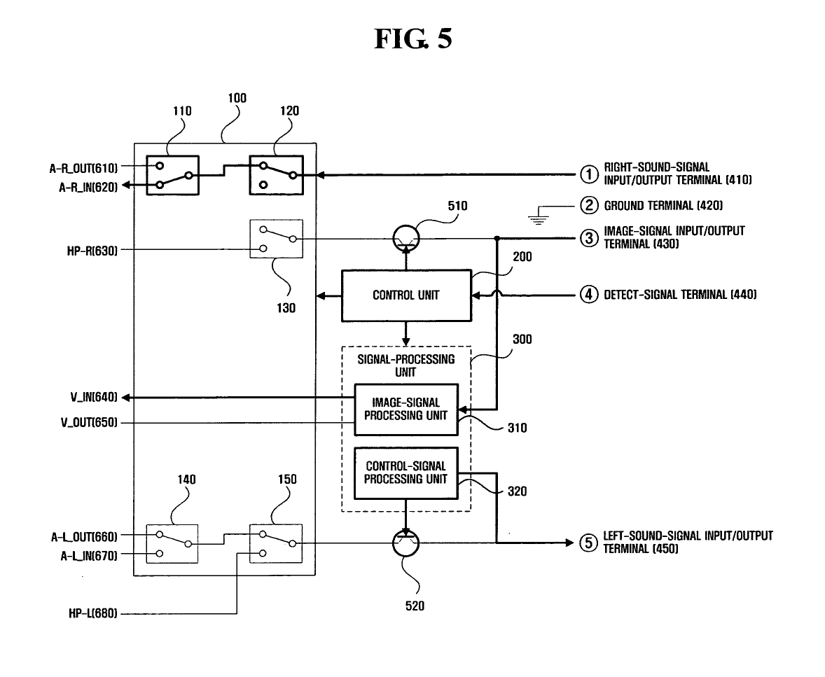

FIG. 5 illustrates a circuit configuration of an apparatus where a control signal is output, and image and sound signals are input according to an exemplary embodiment of the present invention.

A user inputs the corresponding settings via an input means such as buttons included in the apparatus 1000, in order to output the control signal from external device such as an external camera, and receive image and sound signals.

When the cord of the external device is inserted into the input and output unit 400 after the settings are input, the left-sound-signal input and output terminal 450 and the detect-signal terminal 440 are disconnected, which is detected by the control unit 200. The control unit 200 determines the type of the external device through the settings. That is, the control unit detects that the external device outputs image signals and sound signals after receiving a control signal.

The control unit 200 supplies a control voltage to the control-signal processing unit 320, whereby the control-signal processing unit 320 does not connect the left-sound-signal input and output terminal 450 to the fifth switch 150, and outputs a control signal of the external device generated by a control unit 200 via the left-sound-signal input and output terminal 450 by supplying a low level voltage to the second transistor 520.

The control unit 200 instructs the first switch 110 to connect to A-R_IN 620 by supplying a control voltage to the switch unit 100, the second switch 120 to connect to the first switch 110, the third switch 130 to not connect to HP-R 630. As a result, the right-sound-signal input and output terminal 410 is connected to A-R_IN 620, thereby transmitting a sound signal, which is input to the right sound signal input and output terminal 410, to a sound codec (not shown) in the apparatus via A-R_IN 620.

The control unit 200 instructs the image-signal input and output terminal 430 to not connect to the third switch 130 by supplying a low level voltage to the first transistor 510, and has the image signal, which is input to the image-signal input and output terminal 430, transmitted to V_IN 640 by supplying a control voltage to the image-signal processing unit 310.

Therefore, a control signal is output to the external device, and image and sound signals of the external device are input to the apparatus 1000.

For reference, the ground terminal 420 adjusts the electric potential between the apparatus 1000 and the external device.

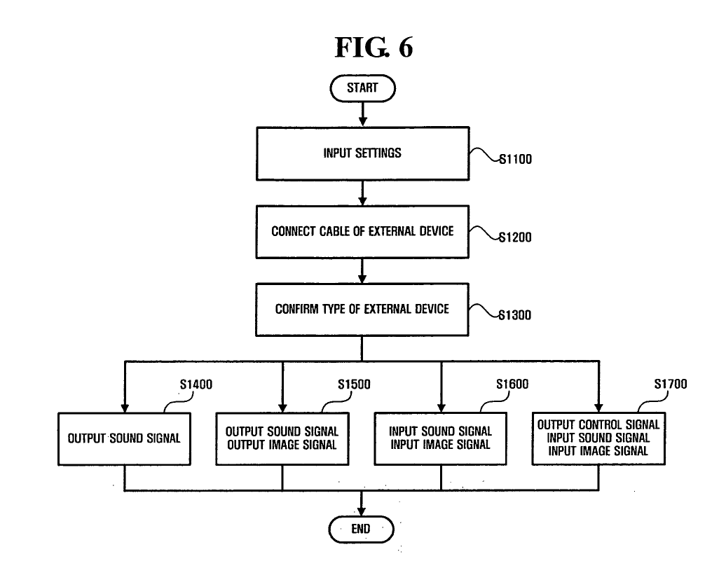

FIG. 6 is a flow chart illustrating a multifunctional input and output process according to an exemplary embodiment of the present invention.

The apparatus 1000 receives the settings from a user in advance in order to perform a multifunctional input and output S1100. As mentioned above, the settings include the type of input or output control, image, or sound signals, and the apparatus 1000 confirms the type of connected external device using the information.

A user may input the settings via an input means such as buttons included on the apparatus 1000.

After the settings are input, the cord of the external device is inserted to the input and output unit 400 of the apparatus 1000 S1200. As a result, the apparatus 1000 detects that the external device is connected thereto. Two terminals, of several terminals composing the input and output unit 400, have been in contact with each other before the cord of the external device is inserted thereto. When the cord of the external device is inserted, two terminals are disconnected. Accordingly, the apparatus can detect the connection of the external device using the change of the voltage of one of the terminals.

The apparatus 1000 confirms the type of currently connected external device through the input settings after detecting the connection of the external device S1300. For reference, the apparatus 1000 may confirm the type of external device through the settings, and also the type of external device through a predetermined signal transmitted by the external device.

In this specification, the apparatus can use one of four types of methods according to a type of external device:

first, a method that outputs only a sound signal S1400;

second, a method that outputs sound signals and image signals S1500;

third, a method that receives sound signals and image signals S1600; and

fourth, a method that outputs a control signal, and receives sound and image signals S1700.

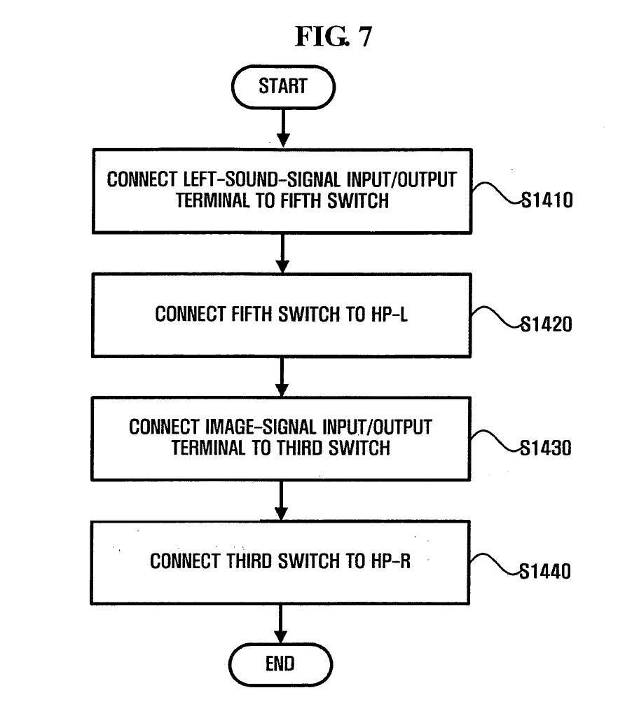

FIG. 7 is a flow chart illustrating a process of outputting a sound signal according to an exemplary embodiment of the present invention.

The control unit 200 of the apparatus 1000 supplies a control voltage to the control-signal processing unit 320. As a result, the control unit 200 instructs the control-signal processing unit 320 to be disconnected from the left-sound-signal input and output terminal 450, and the left-sound-signal input and output terminal 450 to be connected to the fifth switch 150 S1410.

The control unit 200 supplies a control voltage to the switch unit 100. As a result, the control unit 200 instructs the fifth switch 150 to be connected to HP-L 680 S1420, and the left sound signal generated by a sound codec (not shown) to be transmitted to the left-sound-signal input and output terminal 450 via HP-L 680.

The control unit 200 supplies a high level voltage to the first transistor 510, and instructs the image-signal input and output terminal 430 to be connected to the third switch 130 S1430.

The control unit 200 supplies another control voltage to the switch unit 100 and commands the third switch 130 to be connected to HP-R 630 S11440, and then commands the right sound signal generated by a sound codec (not shown) to be transmitted to the right-sound-signal input and output terminal 410 via HP0R 630.

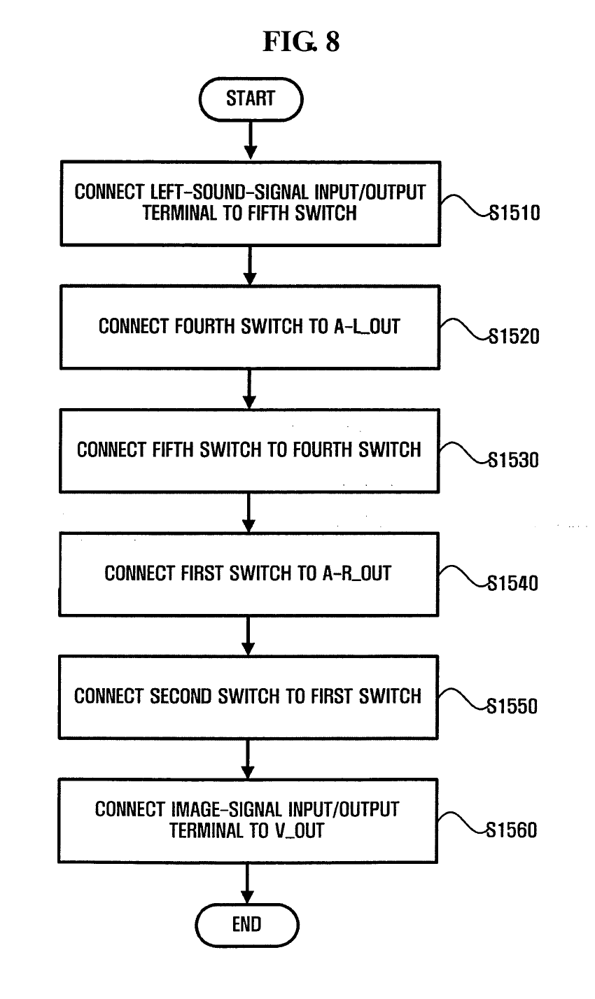

FIG. 8 is a flow chart illustrating a process of outputting image and sound signals according to an exemplary embodiment of the present invention.

The control unit 200 of the apparatus 1000 supplies a control voltage to the control-signal processing unit 320. As a result, the control unit instructs the control-signal processing unit 320 to be disconnected from the left-sound-signal input and output terminal 450, and the left-sound-signal input and output terminal 450 to be connected to the fifth switch 150 S1510.

By supplying a control voltage to the switch unit 100, the control unit 200 instructs the fourth switch 140 to be connected to A-L_OUT 660 S1520, and the fifth switch 150 to be connected to the fourth switch 140 S1530 in order for a left sound signal generated by a sound codec (not shown) to be transmitted to the left-sound-signal input and output terminal 450 via A-L_OUT 660.

By supplying another control voltage to the switch unit 100, the control unit 200 commands the first switch 110 to be connected to A-R_OUT 610 S1540, and the second switch 120 to be connected to the first switch 110 S1550, in order for a right sound signal generated by a sound codec (not shown) to be transmitted to the right-sound-signal input and output terminal 410 through A-R_OUT 610.

By supplying a control voltage to the image-signal processing unit 310, The control unit 200 commands the image-signal input and output terminal 430 to be connected to V_OUT 650 S1560 in order for an image signal generated by an image codec (not shown) to be transmitted to the image-signal input and output terminal 430 via V_OUT 650.

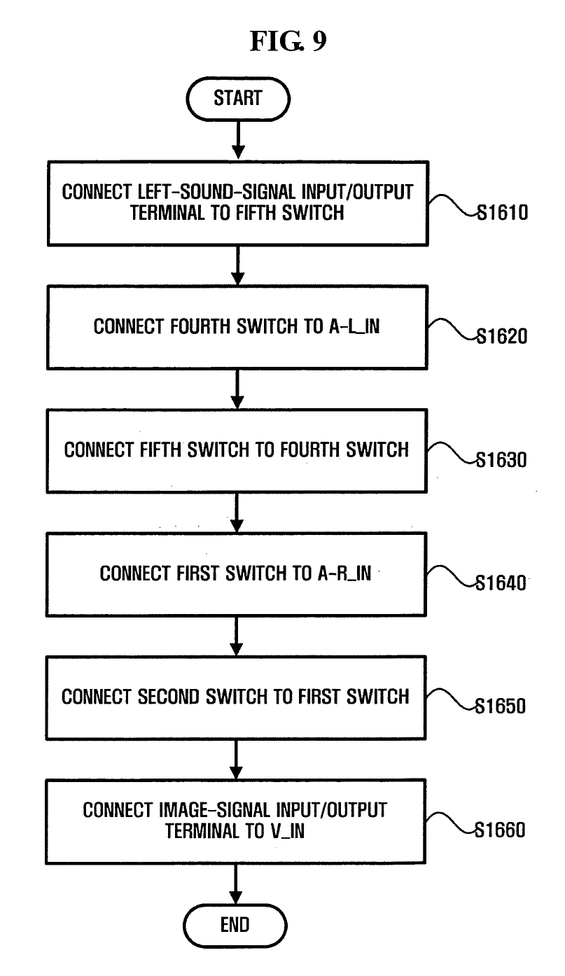

FIG. 9 is a flow chart illustrating a process that receives image and sound signals according to an exemplary embodiment of the present invention.

The control unit 200 of the apparatus 1000 supplies a control voltage to the control-signal processing unit 320. As a result, the control unit 200 instructs the control-signal processing unit 320 to be disconnected with from left-sound-signal input and output terminal 450, and the left-sound-signal input and output terminal 450 to be connected to a fifth switch 150 S1610.

By supplying a control voltage to the switch unit 100, the control unit 200 instructs the fourth switch 140 to be connected to A-L_IN 670 S1620, and the fifth switch 150 to be connected to the fourth switch 140 S1630 in order for a sound signal input to the left-sound-signal input and output terminal 450 to be transmitted to a sound codec (not shown) in the apparatus via A-L_IN 670.

By supplying another control voltage to the switch unit 100, the control unit 200 commands the first switch 110 to be connected to A-R_IN 620 S1640, and the second switch 120 to be connected to the first switch 110 S1650 in order for a sound signal input to the right-sound-signal input and output terminal 410 to be transmitted to a sound codec (not shown) in the apparatus through A-R_IN 620.

By supplying a control voltage to the image-signal processing unit 310, the control unit 200 instructs the image-signal input and output terminal 430 to be connected to V_IN 640 S1660 in order for an image signal, which is input to the image-signal input and output terminal 430 to be transmitted to V_IN 640.

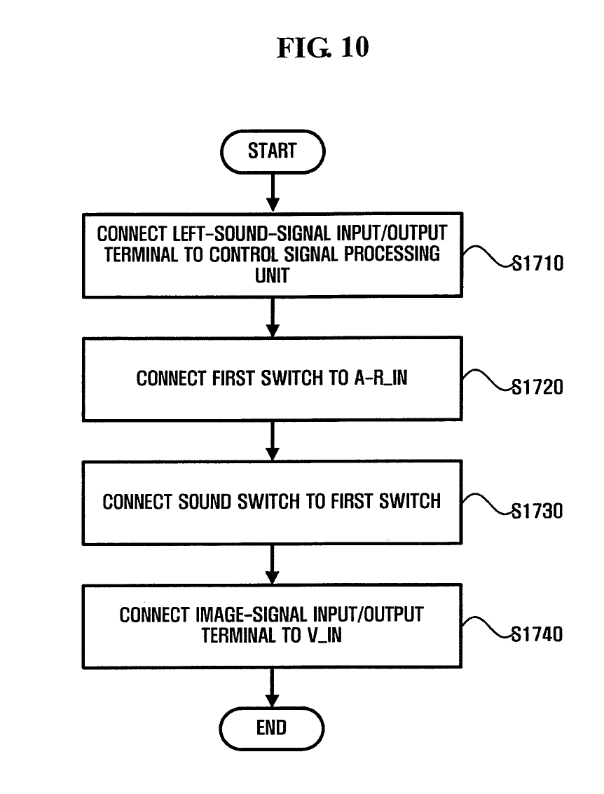

FIG. 10 is a flow chart illustrating a process that outputs a control signal, and receives image and sound signals.

The control unit 200 of the apparatus 1000 supplies a control voltage to the control-signal processing unit 320. As a result, the control unit 200 instructs the control-signal processing unit 320 to be connected to the left-sound-signal input and output terminal 450 S1710. The control-signal processing unit 320 outputs the control signal of the external device generated by the control unit 200 via the left-sound-signal input and output terminal 450.

The control unit 200 supplies a control voltage to the switch unit 100. As a result, the control unit 200 instructs the first switch 110 to be connected to A-R_IN 620 S1720, and the second switch 120 to be connected to the first switch 110 S1730 in order for a sound signal, which is input to the right-sound-signal input and output terminal 410, to be transmitted to a sound codec (not shown) in the apparatus via A-R_IN 620.

The control unit 200 supplies a control voltage to the image-signal processing unit 310. As a result, the control unit 200 commands the image-signal input and output terminal 430 to be connected to V_IN 640 S1740, the control unit 200 commands an image signal, which is input to an image-signal input and output terminal 430, to be transmitted to V_IN 640.

The exemplary embodiments of the present invention can also be embodied as computer-readable codes on a computer-readable medium having an apparatus including a multifunctional input and output jack and a method using the same that produces one or more advantages described below. The computer-readable medium is any data storage device that can store data which can thereafter be read by a computer system. Examples of the computer-readable recording medium include, but art not limited to, read-only memory (ROM), random-access memory (RAM, CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the exemplar embodiments of the present invention can be easily construed as within the scope of the invention by programmers skilled in the art to which the present invention pertains.

First, since image and sound signals are selectively input or output via a single jack commonly used for inputting and outputting, the apparatus can be decreased in size.

Second, since two jacks for inputting and outputting are combined into a single jack, the price cost of manufacturing can be reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus including a multifunctional input and output jack comprising:
a control unit for generating a control voltage according to settings;
a signal-processing unit for processing a progress path so that at least one of a control signal and an image signal in accordance with an external device is at least one of input and output according to the control voltage;
a switch unit for processing a progress path so that a sound signal in accordance with the external device is at least one of input and output according to the control voltage; and
an input and output unit for at least one of inputting and outputting at least one of the control signal, the image signal and the sound signal according to the progress path.

2. The apparatus of claim 1, wherein the settings include a type of the at least one the input and output control signal, image signal, and sound signal.

3. The apparatus of claim 1, wherein the control voltage comprises at least one of a high level voltage and a low level voltage.

4. The apparatus of claim 3, wherein a range of the high level voltage comprises 0.4-0.8 V.

5. The apparatus of claim 1, wherein the control unit determines a type of the external device through the settings.

6. The apparatus of claim 1, wherein the input and output unit includes at least one of the left-sound-signal input and output terminal, the right-sound-signal input and output terminal, the image-signal input and output terminal, the detect-signal terminal, and the ground terminal.

7. The apparatus of claim 6, wherein the control unit detects a connection with the external device when the left-sound-signal input and output terminal and the detect-signal terminal are disconnected.

8. A multifunctional input and output method comprising:
generating a control voltage according to settings;
processing a progress path so that at least one of a control signal and image signal in accordance with an external device is at least one of input and output according to the control voltage;
processing a progress path so that a sound signal in accordance with the external device is at least one of input and output according to the control voltage; and
at least one of inputting and outputting at least one of the control signal, the image signal and the sound signal according to the progress path.

9. The method of claim 8, wherein the settings include a type of at least one of the input and output control signal, image signal, and sound signal.

10. The method of claim 8, wherein the control voltage comprises at least one of a high level voltage and a low level voltage.

11. The method of claim 10, wherein the range of the high level voltage comprises 0.4-0.8 V.

12. The method of claim 8, wherein the generating of the control voltage includes determining a type of the external device through the settings.

13. The method of claim 8, wherein the at least one of the inputting and outputting includes at least one of inputting and outputting at least one of the control signal, the image signal, and the sound signal via at least one of the left-sound-signal input and output terminal, the right-sound-signal input and output terminal, the image-signal input and output terminal, the detect-signal terminal, and the ground terminal.

14. The method of claim 13, wherein the generating of the control voltage includes detecting a connection with the external device when the left-sound-signal input and output terminal and the detect signal terminal are disconnected.

15. A computer-readable recording medium comprising a multifunctional input and output method, the method comprising:
generating a control voltage according to settings;
processing a progress path so that at least one of a control signal and image signal in accordance with an external device is at least one of input and output according to the control voltage;
processing a progress path so that a sound signal in accordance with the external device is at least one of input and output according to the control voltage; and
at least one of inputting and outputting at least one of the control signal, the image signal and the sound signal according to the progress path.

16. The method of claim 15, wherein the settings include a type of at least one of the input and output control signal, image signal, and sound signal.

17. The method of claim 15, wherein the control voltage comprises at least one of a high level voltage and a low level voltage.

18. The method of claim 17, wherein the range of the high level voltage comprises 0.4-0.8 V.

19. The method of claim 15, wherein the generating of the control voltage includes determining a type of the external device through the settings.

20. The method of claim 15, wherein the at least one of the inputting and outputting includes at least one of inputting and outputting at least one of the control signal, the image signal, and the sound signal via at least one of the left-sound-signal input and output terminal, the right-sound-signal input and output terminal, the image-signal input and output terminal, the detect-signal terminal, and the ground terminal.

21. The method of claim 20, wherein the generating of the control voltage includes detecting a connection with the external device when the left-sound-signal input and output terminal and the detect signal terminal are disconnected.
